(19) United States
(12) Patent Application Publication
(10) Pub. No.: US 2026/0321992 A1
(43) Pub. Date: Oct. 15, 2026

(54) ANTENNA ARRAY, ANTENNA STRUCTURE, AND COMMUNICATION DEVICE

(71) Applicant: HUAWEI TECHNOLOGIES CO., LTD., Shenzhen (CN)

(72) Inventors: Zijing DU, Xi'an (CN); Jun SHU, Dongguan (CN); Yulin CHANG, Dongguan (CN); Zhenxing WAN, Dongguan (CN); Hui HU, Dongguan (CN)

(73) Assignee: HUAWEI TECHNOLOGIES CO., LTD., Shenzhen (CN)

(21) Appl. No.: 19/699,630

(22) Filed: Jun. 5, 2026

Related U.S. Application Data
(63) Continuation of application No. PCT/CN2024/136708, filed on Dec. 4, 2024.

(30) Foreign Application Priority Data
Dec. 8, 2023 (CN) 202311692547.8

(51) Int. Cl. H01Q 21/26; H01Q 1/12; H01Q 1/42; H01Q 1/52; H01Q 5/20; H01Q 5/307

(52) U.S. Cl. CPC H01Q 21/26; H01Q 1/12; H01Q 1/42; H01Q 1/521; H01Q 5/20; H01Q 5/307

(57) ABSTRACT

Embodiments of this application provide an antenna array, an antenna structure, and a communication device, relating to the field of radio communication technologies, to reduce interference from a high-frequency radiating element to a low-frequency radiating element in the antenna array.

### CROSS-REFERENCE TO RELATED APPLICATIONS

This application is a continuation of International Application No. PCT/CN2024/136708, filed on Dec. 4, 2024, which claims priority to Chinese Patent Application No. 202311692547.8, filed on Dec. 8, 2023. The disclosures of the aforementioned applications are hereby incorporated by reference in their entireties.

### TECHNICAL FIELD

The present invention relates to the field of radio communication technologies, and in particular, to an antenna array, an antenna structure, and a communication device.

### BACKGROUND

With rapid development of wireless communication technologies, capacity requirements for communication systems are increasingly high, and multi-band antennas are widely used in base station antennas. Generally, a multi-band base station antenna usually includes a low-frequency radiating element and a high-frequency radiating element.

However, because there is a coupling between the low-frequency radiating element and the high-frequency radiating element, when the low-frequency radiating element operates, the high-frequency radiating element interferes with signals transmitted by the low-frequency radiating element.

### SUMMARY

An objective of the present invention is to provide an antenna array, an antenna structure, and a communication device, to reduce interference from a high-frequency radiating element to a low-frequency radiating element in the antenna array.

The following technical solutions are used in embodiments of this application, to achieve the foregoing objective.

According to a first aspect of embodiments of this application, an antenna array is provided, including a metal ground plane and a first radiating element and a second radiating element that are disposed on the metal ground plane. The first radiating element has a first frequency f₁, the second radiating element has a second frequency f₂, and f₂<f₁. The first radiating element includes a first antenna element, a first balun structure, and a decoupling structure. The first balun structure is located between the first antenna element and the metal ground plane, and the first balun structure is electrically connected to the first antenna element and the metal ground plane. The decoupling structure is insulated from the metal ground plane, and the decoupling structure includes at least one primary split-ring stub. The primary split-ring stub is located between the first antenna element and the metal ground plane. At least a part of the primary split-ring stub extends across the metal ground plane. In addition, an end of the primary split-ring stub facing away from the metal ground plane is provided with a first opening. Both ends of the primary split-ring stub at the first opening are electrically connected to the first balun structure.

It can be learned from the foregoing descriptions that the antenna array includes the first radiating element, the first radiating element includes the first antenna element and the first balun structure, the first antenna element can receive or send an electromagnetic wave signal, and the first balun structure can transmit a radio frequency signal, to complete radio frequency signal exchange between the first antenna element of the first radiating element and another apparatus. In addition, the first frequency f₁ of the first radiating element is greater than the second frequency f₂ of the second radiating element. In this way, the antenna array can receive or send a higher-frequency electromagnetic wave signal, and can also receive or send a lower-frequency electromagnetic wave signal. In a related technology, when the second radiating element operates, under impact of an electromagnetic wave that has the second frequency f₂ and is sent by the second radiating element, an induced current having the second frequency f₂ is generated in the first balun structure, and then an electromagnetic wave having the second frequency f₂ is generated, which causes interference to an electromagnetic wave signal sent by the second radiating element, deteriorates a scattering parameter of the second radiating element, and results in distortion of a radiation pattern of the second radiating element. However, the first radiating element of the antenna array provided in embodiments of this application further includes the decoupling structure, and the decoupling structure includes the at least one primary split-ring stub located between the first antenna element and the metal ground plane. When the second radiating element operates, and the induced current having the second frequency f₂ is generated in the first balun structure, a direction of the induced current alternates at a frequency of f₂. In this case, an alternating current having the second frequency f₂ is also generated in the primary split-ring stub. However, the at least part of the primary split-ring stub extends across the metal ground plane. In this case, a direction of a current in the at least part of the primary split-ring stub is opposite to a direction of the current in the first balun structure, and directions of generated magnetic fields are also opposite. In other words, when the second radiating element operates normally, the induced current is generated in the first balun structure of the first radiating element, and the magnetic field is generated through electromagnetic induction, the primary split-ring stub of the decoupling structure generates the magnetic field in the opposite direction, to reduce intensity of a total magnetic field generated by the first radiating element, thereby reducing intensity of the electromagnetic wave sent from the first radiating element. In this way, interference from the first radiating element to the second radiating element in the antenna array is reduced. In other words, interference from a high-frequency radiating element to a low-frequency radiating element in the antenna array is reduced. In addition, the decoupling structure is insulated from the metal ground plane, to prevent the decoupling structure from being electrically connected to the metal ground plane directly, without directly connecting the decoupling structure to the metal ground plane, thereby ensuring normal operating of the antenna array.

In some embodiments of this application, the primary split-ring stub includes a first stub, a second stub, and an electrical connector. At least a part of the first stub extends across the metal ground plane. At least a part of the second stub extends across the metal ground plane, the first stub and the second stub are respectively located on two sides of the first balun structure, a first end of the first stub and a first end of the second stub are electrically connected to the first balun structure separately, and the first opening is provided between the first end of the first stub and the first end of the second stub. The electrical connector is located between the first stub and the second stub, and is electrically connected to a second end of the first stub and a second end of the second stub. A principle is the same as that of the foregoing embodiment. The first end of the first stub and the first end of the second stub are electrically connected to the first balun structure separately. When the direction of the induced current in the first balun structure is a direction facing away from the metal ground plane, the induced current flows, to the first end of the first stub, from an end of the first balun structure facing the metal ground plane, and flows to the electrical connector through the first stub. The at least part of the first stub extends across the metal ground plane, that is, a direction of a current in the part faces the metal ground plane. In this way, a magnetic field whose direction is opposite to that of the magnetic field generated by the first balun structure can be generated. When the direction of the induced current in the first balun structure is a direction facing the metal ground plane, the induced current flows, toward the metal ground plane, from a joint between the first end of the first stub and the first balun structure to the end of the first balun structure facing the metal ground plane. In this case, a current flowing from the second end to the first end is generated in the first stub. A direction of the current in the first stub faces away from the metal ground plane. In this way, a magnetic field whose direction is opposite to that of the magnetic field generated by the first balun structure can be generated. Therefore, the magnetic field whose direction is opposite to that of the magnetic field generated by the first balun structure is always generated in the first stub, to weaken the magnetic field generated by the first radiating element. Similarly, the second stub can also generate a magnetic field whose direction is opposite to that of the magnetic field generated by the first balun structure, to further weaken the magnetic field generated by the first radiating element. In this way, the interference from the first radiating element to the second radiating element in the antenna array is reduced. In addition, both the second end of the first stub and the second end of the second stub are electrically connected to the electrical connector, so that the electrical connector can electrically connect the first stub to the second stub. This can reduce impedance of the primary split-ring stub, to increase currents generated by the first stub and the second stub, and ensure that intensity of the magnetic fields generated by the first stub and the second stub can furthest weaken the magnetic field generated by the first balun structure.

In some embodiments of this application, the first stub includes a first horizontal stub and a first vertical stub. The first horizontal stub is parallel to the metal ground plane, an end of the first horizontal stub facing the first balun structure is electrically connected to the first balun structure, and the first opening is provided between an end of the first horizontal stub facing away from the first balun structure and the first end of the second stub. The first vertical stub is perpendicular to the metal ground plane, an end of the first vertical stub facing away from the metal ground plane is electrically connected to the end of the first horizontal stub facing away from the first balun structure, and an end of the first vertical stub facing the metal ground plane is electrically connected to the electrical connector. The first horizontal stub can ensure that the first vertical stub is electrically connected to the first balun structure. In this way, a current whose direction is opposite to that of the current in the first balun structure can be generated in the first vertical stub. In this way, a direction of a magnetic field generated by the first vertical stub is opposite to that of the magnetic field generated by the first balun structure. This can achieve reverse cancellation effect, to weaken the magnetic field generated by the first radiating element, thereby reducing the intensity of the electromagnetic wave sent from the first radiating element.

In some embodiments of this application, the first vertical stub includes a first longitudinal section, a second longitudinal section, and a first U-shaped section. The first longitudinal section is electrically connected to the end of the first horizontal stub facing away from the first balun structure, and the second longitudinal section is electrically connected to the electrical connector. The first U-shaped section is disposed between the first longitudinal section and the second longitudinal section, and the first U-shaped section is electrically connected to the first longitudinal section and the second longitudinal section separately. When a height of the first balun structure is low, or available space on a periphery of the first balun structure is small, the first stub uses a manner of sequentially connecting the first longitudinal section, the first U-shaped section, and the second longitudinal section. This can increase a length of the first vertical stub, thereby increasing the impedance of the primary split-ring stub, and reducing a magnitude of a current flowing to the primary split-ring stub when the first radiating element operates normally.

In some embodiments of this application, the first stub extends across the metal ground plane, the first end of the first stub is disposed close to the first balun structure, and the second end of the first stub is disposed away from the first balun structure. When available space in an area on a periphery of an upper half of the first balun structure is smaller, and available space in an area on a periphery of a lower half of the first balun structure is larger, it is ensured that the first stub can be disposed on one side of the first balun structure.

In some embodiments of this application, the second stub includes a second horizontal stub and a second vertical stub. The second horizontal stub is parallel to the metal ground plane, an end of the second horizontal stub facing the first balun structure is electrically connected to the first balun structure, and the first opening is provided between the end of the second horizontal stub facing the first balun structure and the first end of the first stub. The second vertical stub is perpendicular to the metal ground plane, an end of the second vertical stub facing away from the metal ground plane is electrically connected to an end of the second horizontal stub facing away from the first balun structure, and an end of the second vertical stub facing the metal ground plane is electrically connected to the electrical connector. Same as that in the foregoing embodiment, it can be ensured that a direction of a magnetic field generated by the second vertical stub is opposite to that of the magnetic field generated by the first balun structure. This can achieve reverse cancellation effect, to weaken the magnetic field generated by the first radiating element, thereby reducing the intensity of the electromagnetic wave sent from the first radiating element.

In some embodiments of this application, the first antenna element includes a first dipole element, and the first dipole element includes a first sub-element and a second sub-element. The first balun structure includes a first balun arm and a second balun arm, the first balun arm is connected to the first sub-element, and the second balun arm is connected to the second sub-element. The first end of the first stub is electrically connected to the first balun arm, and the first end of the second stub is electrically connected to the second balun arm. When the second radiating element operates, because both the first balun arm and the second balun arm are in a magnetic field of the second radiating element, induced currents having the second frequency f₂ are generated in both the first balun arm and the second balun arm, and directions of the induced currents are the same. In this case, the first end of the first stub is electrically connected to the first balun arm, to generate a current whose direction is opposite to that of the current in the first balun arm, thereby weakening a magnetic field generated by the first balun arm. Similarly, the second stub can weaken a magnetic field generated by the second balun arm. In this way, the intensity of the electromagnetic wave sent from the first radiating element is reduced.

In some embodiments of this application, there are two primary split-ring stubs, the first antenna element further includes a second dipole element, and the second dipole element includes a third sub-element and a fourth sub-element. The first balun structure further includes a third balun arm and a fourth balun arm, the third balun arm is connected to the third sub-element, and the fourth balun arm is connected to the fourth sub-element. For one of the primary split-ring stubs, a first end of a first stub is electrically connected to the first balun arm, and a first end of a second stub is electrically connected to the second balun arm. For the other primary split-ring stub, a first end of a first stub is electrically connected to the third balun arm, and a first end of a second stub is electrically connected to the fourth balun arm. The first dipole element and the second dipole element operate in a transmit and receive duplex mode at the same time, which reduces a number of first radiating elements that need to be disposed in the antenna array. In addition, same as those in the foregoing embodiment, for the one of the primary split-ring stubs, the first stub can weaken the magnetic field generated by the first balun arm, and the second stub can weaken the magnetic field generated by the second balun arm. For the other primary split-ring stub, the first stub can weaken a magnetic field generated by the third balun arm, and the second stub can weaken a magnetic field generated by the fourth balun arm. In this way, the intensity of the electromagnetic wave sent from the first radiating element is reduced.

In some embodiments of this application, the two primary split-ring stubs are electrically connected to each other at ends facing the metal ground plane. In this case, different primary split-ring stubs are connected in parallel, so that the decoupling structure has smaller total inductance and smaller total inductive reactance, to increase a magnitude of a current in the decoupling structure. In this way, when the induced current is generated in the first balun structure, the magnitude of the current in the decoupling structure is closer to that of the current in the first balun structure, so that intensity of a magnetic field generated by the decoupling structure is close to the intensity of the magnetic field generated by the first balun structure. This improves the reverse cancellation effect, and reduces the interference from the first radiating element to the second radiating element in the antenna array.

In addition, a formula of a frequency of a radiated electromagnetic wave of an LC oscillation circuit is as follows:

$$f = \frac{1}{2 π \sqrt{LC}}$$

Herein, f is the frequency of the radiated electromagnetic wave, Lis inductive reactance of a current line, and C is capacitive reactance of the current line.

When the decoupling structure has the smaller total inductance, the decoupling structure is applicable to a lower operating frequency of the second radiating element, so that the decoupling structure is applicable to a wider operating frequency band of the second radiating element.

In some embodiments of this application, the electrical connector is a sheet-like structure and is parallel to the metal ground plane. In this case, the primary split-ring stub has small capacitance and large capacitive reactance. A formula of a frequency of a radiated electromagnetic wave of an LC oscillation circuit is as follows:

$$f = \frac{1}{2 π \sqrt{LC}}$$

In this case, the decoupling structure is applicable to a lower operating frequency of the second radiating element, so that the decoupling structure is applicable to a wider operating frequency band of the second radiating element.

In some embodiments of this application, the primary split-ring stub includes a first part and a second part, electrical lengths of the first part and the second part are equal, and the first opening is provided between an end of the first part facing away from the metal ground plane and an end of the second part facing away from the metal ground plane. The first balun structure includes a first balun arm and a second balun arm, both the first balun arm and the second balun arm are connected to the metal ground plane, the end of the first part facing away from the metal ground plane is electrically connected to the first balun arm, a length of the first part is D₁, a distance between a connection point between the first part and the first balun arm and a connection point between the first balun arm and the metal ground plane is H₁, and λ_{H}/4≤D₁+H₁≤λ_{L}/2. The end of the second part facing away from the metal ground plane is electrically connected to the second balun arm, a length of the second part is D₂, a distance between a connection point between the second part and the second balun arm and a connection point between the second balun arm and the metal ground plane is H₂, and λ_{H}/4<D₂+H₂≤λ_{L}/2. Herein, λ_{H} is a wavelength corresponding to the first frequency f₁ of the first radiating element, and λ_{L} is a wavelength corresponding to the second frequency f₂ of the second radiating element.

When D₁+H₁≤λ_{L}/2, directions of a current in the first balun arm and currents in all parts of the first part all change with a change of a direction of an electromagnetic wave in the second radiating element, and the directions of the currents in all the parts of the first part change at the same time. In this case, a direction of an electromagnetic wave generated by the first balun arm is always opposite to a direction of an electromagnetic wave generated by at least one section of the first part, to implement reverse cancellation. Similarly, when D₂+H₂≤λ_{L}/2, a direction of an electromagnetic wave generated by the second balun arm is always opposite to a direction of an electromagnetic wave generated by at least one section of the second part, to implement reverse cancellation.

When D₁+H₁>λ_{L}/2, and the direction of the electromagnetic wave in the second radiating element changes, a change of a current in a section of the first part close to a connection point between the first part and the second part is delayed, and consequently, a flow direction of the current in the section is opposite to a flow direction of a current in another section of the first part. As a result, a magnetic field generated by the section may not be able to reversely cancel a magnetic field generated by the first balun arm. Similarly, when D₂+H₂>λ_{L}/2, a change of a current in a section of the second part close to the connection point between the second part and the first part is delayed, and consequently, a flow direction of the current in the section is opposite to the flow direction of the current in the another section of the first part. As a result, the magnetic field generated by the section of the first part cannot reversely cancel a magnetic field generated by the second balun arm, and the interference from the first radiating element to the second radiating element in the antenna array cannot be reduced.

In addition, when D₁+H₁>λ_{H}/4, and the first radiating element operates, impedance of the first part of the decoupling structure is large, and is far greater than impedance of the first balun arm, and a current flowing to the first part is far lower than a current in the first balun arm. In this case, an electromagnetic wave generated by the first part may be ignored. Similarly, when D₂+H₂≥λ_{H}/4, an electromagnetic wave generated by the second part may be ignored, that is, impact of the decoupling structure on operating of the first radiating element may be ignored.

In some embodiments of this application, the decoupling structure further includes at least one secondary split-ring stub. The secondary split-ring stub is disposed on a side of the primary split-ring stub facing away from the metal ground plane, and an end of each secondary split-ring stub facing the metal ground plane is electrically connected to the primary split-ring stub. In this case, the primary split-ring stub and the secondary split-ring stub are connected in parallel, so that the parallel decoupling structure has smaller total inductance. A formula of a frequency of a radiated electromagnetic wave of an LC oscillation circuit is as follows:

$$f = \frac{1}{2 π \sqrt{LC}}$$

In this case, the decoupling structure is applicable to a lower operating frequency of the second radiating element, so that the decoupling structure is applicable to a wider operating frequency band of the second radiating element.

A second aspect of embodiments of this application provides an antenna structure. The antenna structure may include any one of the foregoing antenna arrays. The antenna structure further includes a radome. The antenna array is disposed in the radome. The antenna structure has same technical effect as the antenna array provided in the foregoing embodiments. Details are not described herein again.

A third aspect of embodiments of this application provides a communication device. The communication device may include the foregoing antenna structure. The communication device may further include a communication support. The antenna structure is disposed on the communication support. The communication device has same technical effect as the antenna structure provided in the foregoing embodiments. Details are not described herein again.

### BRIEF DESCRIPTION OF DRAWINGS

FIG. 1 is a diagram of a structure of a communication system architecture according to an embodiment of this application;

FIG. 2 is a diagram of a structure of a communication device according to an embodiment of this application;

FIG. 3 is a diagram of a structure of an antenna structure according to an embodiment of this application;

FIG. 4 is a diagram of a structure of an antenna array according to an embodiment of this application;

FIG. 5 is a diagram of a structure of an antenna array in a related technology;

FIG. 6 is a diagram of radiation patterns of a second radiating element in a related technology and an embodiment of this application;

FIG. 7 is a diagram of radiation gains of a second radiating element in a related technology and an embodiment of this application;

FIG. 8A is an assembly diagram of a first radiating element and a metal ground plane of an antenna array according to an embodiment of this application;

FIG. 8B is a diagram of a flow direction of a current in a first radiating element of an antenna array according to an embodiment of this application;

FIG. 8C is a diagram of another flow direction of a current in a first radiating element of an antenna array according to an embodiment of this application;

FIG. 9 is a main view of FIG. 8A;

FIG. 10 is a diagram of a structure of another antenna array according to an embodiment of this application;

FIG. 11 is a main view of FIG. 10;

FIG. 12 is a diagram of a structure of another antenna array according to an embodiment of this application;

FIG. 13 is a main view of FIG. 12;

FIG. 14 is a diagram of a structure of another antenna array according to an embodiment of this application; and

FIG. 15 is a main view of FIG. 14.

### REFERENCE NUMERALS

01: communication system architecture; 02: communication device; 10: antenna structure; 11: antenna array; 111: metal ground plane; 112: first radiating element; 1121: first antenna element; 11211: first dipole element; b1: first sub-element; b2: second sub-element; 11212: second dipole element; b3: third sub-element; b4: fourth sub-element; 1122: first balun structure; 11221: first balun arm; 11222: second balun arm; 11223: third balun arm; 11224: fourth balun arm; 1123: decoupling structure; 11231: primary split-ring stub; a1: first opening; a2: first part; a3: second part; a4: first stub; a41: first horizontal stub; a42: first vertical stub; a421: first longitudinal section; a422: second longitudinal section; a423: first U-shaped section; a424: third longitudinal section; a5: second stub; a51: second horizontal stub; a52: second vertical stub; a521: fourth longitudinal section; a522: fifth longitudinal section; a523: second U-shaped section; a6: electrical connector; 11232: secondary split-ring stub; 113: second radiating element; 1131: second antenna element; 1132: second balun structure; 12: radome; 13: feed network; 14: transmission component; 15: calibration network; 16: antenna connector; 20: communication support; 21: pole; 22: adjustment arm; 23: fixture; and 03: terminal device.

### DESCRIPTION OF EMBODIMENTS

The following describes technical solutions in embodiments of this application with reference to accompanying drawings in embodiments of this application. It is clear that the described embodiments are merely a part rather than all of embodiments of this application.

In the following descriptions, the terms “first”, “second”, “third”, “fourth”, and the like are intended merely for ease of description, and shall not be interpreted as indicating or implying relative importance or implying a number of indicated technical features. Therefore, a feature limited by “first”, “second”, “third”, “fourth”, or the like may explicitly or implicitly include one or more features. In descriptions of this application, unless otherwise stated, “a plurality of” means two or more.

In this application, unless otherwise expressly specified and limited, the term “connection” should be understood in a broad sense. For example, “connection” may be a fixed mechanical connection, or may be a detachable mechanical connection or an integrated connection. Alternatively, “connection” may be a direct connection, or may be an indirect connection via an intermediate medium.

In embodiments of this application, a term like “example” or “for example” is used to represent giving an example, an illustration, or a description. Any embodiment or design scheme described as “example” or “for example” in embodiments of this application should not be explained as being more preferred or having more advantages than another embodiment or design scheme. Exactly, use of the term like “example” or “for example” is intended to present a related concept in a specific manner.

In addition, in some embodiments, an electrical length may be a ratio of a physical length (a mechanical length or a geometric length) to a wavelength of a transmitted electromagnetic wave. The electrical length may satisfy the following formula:

$$\overline{L} = \frac{L}{λ}$$

L is the physical length, and 2 is the wavelength of the electromagnetic wave.

In some embodiments of this application, a physical length of a radiator may be understood as being an electrical length of the radiator with ±20%, ±10%, or ±5% of the electrical length of the radiator.

Limitations such as parallel, vertical, and same (for example, a same electrical length) mentioned in embodiments of this application are all for a present process level, but are not absolutely strict definitions in a mathematical sense. There may be a deviation of a predetermined angle between two components that are parallel or perpendicular to each other. In an embodiment, the predetermined angle may be an angle within a range of ±10°. For example, the deviation of the predetermined angle is ±5°.

In the accompanying drawings of embodiments of this application, an assembly is represented by using a guide line with an arrow, a component is represented by using only a guide line, and a hollow-out structure like an opening is represented by using a guide line with a hollow circle at one end.

FIG. 1 shows a communication system architecture 01 according to an embodiment of this application. The communication system architecture 01 may include a communication device 02 and a terminal device 03. The communication device 02 may perform wireless communication with the terminal device 03. For example, the communication device 02 may include a base station. The base station is configured to perform cell coverage of a radio signal to connect a terminal device to a wireless network radio frequency end. Based on this, for example, the base station may be a base transceiver station (base transceiver station, BTS) in a global system for mobile communications (global system of mobile communications, GSM) or a code division multiple access (code division multiple access, CDMA) system. Alternatively, for another example, the base station may be a NodeB (NodeB, NB) in a wideband code division multiple access (wideband code division multiple access wireless, WCDMA) system. Alternatively, for another example, the base station may be an evolved NodeB (evolutional NodeB, eNB) in a long term evolution (long term evolution, LTE) system, or a radio controller in a cloud radio access network (cloud radio access network, CRAN) scenario. Alternatively, the base station may be a relay station, an access point, a vehicle-mounted device, a wearable device, or a base station in a 5G network, or may be a base station or the like in a future evolved public land mobile network (public land mobile network, PLMN), for example, a new radio base station. This is not limited in embodiments of this application.

In addition, the terminal device 03 may be a mobile phone, a tablet computer (pad), a notebook computer, a smart home, a smart wearable device (for example, a smartwatch, a smart band, smart glasses, or a smart helmet), a virtual reality (virtual reality, VR) device, an augmented reality (augmented reality, AR) device, or the like. The terminal device 03 may alternatively be a handheld terminal device having a wireless communication function, a compute device, another processing device connected to a wireless modem, a vehicle-mounted device, a device in a 5G network, a terminal device in a future evolved PLMN, or the like. This is not limited in embodiments of this application.

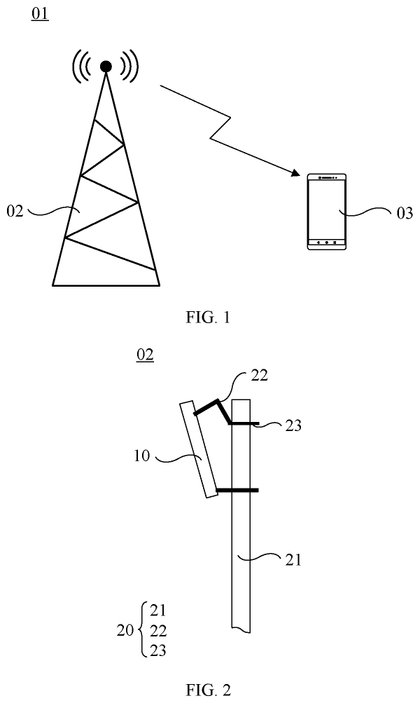

When the communication device 02 is a base station, in some embodiments of this application, the communication device 02 may include an antenna structure 10 and a communication support 20 shown in FIG. 2. The antenna structure 10 is disposed on the communication support 20.

For example, the communication support 20 may include a pole 21, and the pole 21 may be used to fasten and support the antenna structure 10. In addition, the communication support 20 may further include an adjustment arm 22 and a fixture 23. The adjustment arm 22 is located between the antenna structure 10 and the pole 21. One end of the fixture 23 is connected to the adjustment arm 22, and the other end of the fixture 23 is connected to the pole 21. The antenna structure 10 may be connected to the pole 21 via the adjustment arm 22 and the fixture 23 sequentially. The adjustment arm 22 may be used to adjust a tilt angle of the antenna structure 10 relative to the pole 21.

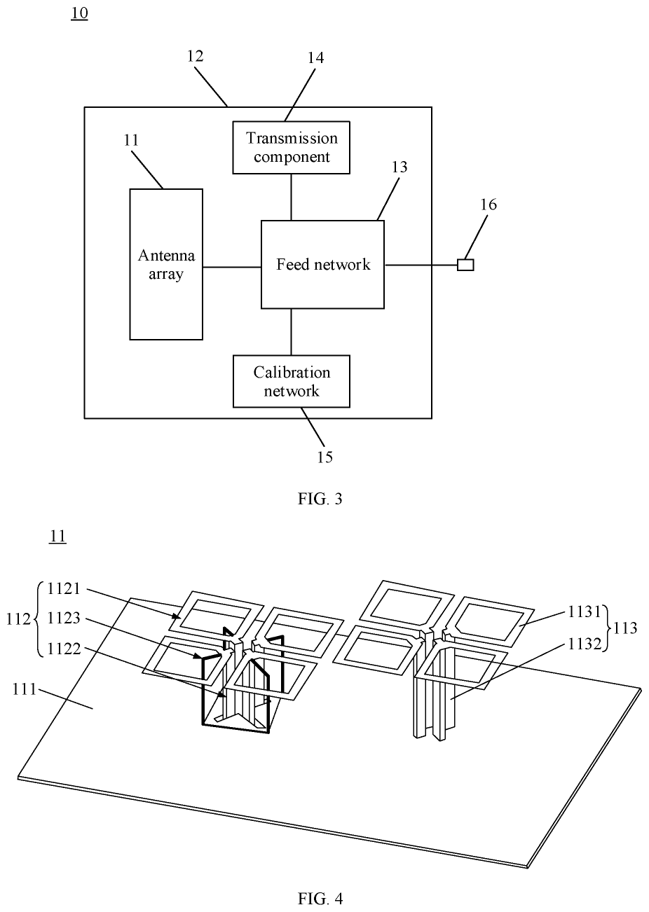

On this basis, as shown in FIG. 3, the antenna structure 10 may include an antenna array 11 and a radome 12, and the antenna array 11 is disposed in the radome 12. The radome 12 can further resist impact of an external environment of the antenna structure 10, to protect the antenna array 11.

In addition, still as shown in FIG. 3, the antenna structure 10 further includes a feed network 13. For example, the feed network 13 may include a phase shifter, a filter, and a combiner. The antenna array 11 receives or transmits a radio frequency signal via the feed network 13.

Still as shown in FIG. 3, the antenna structure 10 may further include a transmission component 14. The transmission component 14 is electrically connected to the feed network 13. The feed network 13 may implement different radiation beam directions via the transmission component 14.

Still as shown in FIG. 3, the antenna structure 10 may further include a calibration network 15, and the calibration network 15 is electrically connected to the feed network 13. The feed network 13 may obtain, via the calibration network 15, a calibration signal required by a system.

Still as shown in FIG. 3, the antenna structure 10 may further include an antenna connector 16, and the antenna connector 16 is electrically connected to the feed network 13. The antenna connector 16 is configured to connect to an external device, to complete radio frequency signal exchange between the antenna structure 10 and the external device.

On this basis, as shown in FIG. 4, the antenna array 11 may include a metal ground plane 111 and a first radiating element 112 and a second radiating element 113 that are disposed on the metal ground plane 111. The first radiating element 112 has a first frequency f₁, that is, the first radiating element 112 may send or receive an electromagnetic wave having the first frequency f₁. The second radiating element 113 has a second frequency f₂, and f₂<f₁, that is, the second radiating element 113 may send or receive an electromagnetic wave having the second frequency f₂. In addition, because f₂<f₁, a frequency of an electromagnetic wave that can be received or sent by the first radiating element 112 is higher, and a frequency of an electromagnetic wave that can be received or sent by the second radiating element 113 is lower. In this way, the antenna array 11 can receive or send a higher-frequency electromagnetic wave signal, and can also receive or send a lower-frequency electromagnetic wave signal. In other words, the first radiating element 112 is a high-frequency radiating element, and the second radiating element 113 is a low-frequency radiating element.

In an implementation, the first frequency f₁ is approximately four times the second frequency f₂. In another implementation, the first frequency f₁ may alternatively be approximately another multiple of the second frequency f₂. This is not specifically limited in this embodiment. For example, the first frequency f₁ is 2500 MHZ, and the second frequency f₂ is 750 MHz.

As shown in FIG. 4, the first radiating element 112 may include a first antenna element 1121 and a first balun structure 1122. The first balun structure 1122 is located between the first antenna element 1121 and the metal ground plane 111, and the first balun structure 1122 is electrically connected to the first antenna element 1121 and the metal ground plane 111. It can be learned from the foregoing descriptions that, after receiving an electromagnetic wave signal, the first antenna element 1121 transmits the electromagnetic wave signal to the metal ground plane 111 via the first balun structure 1122, and then transmits the electromagnetic wave signal out of the antenna array 11. Alternatively, when the first antenna element 1121 needs to transmit an electromagnetic wave signal, a radio frequency signal is transmitted to the first balun structure 1122 via the metal ground plane 111, the radio frequency signal is transmitted to the first antenna element 1121 via the first balun structure 1122, and after receiving the radio frequency signal, the first antenna element 1121 sends an electromagnetic wave to the outside. In this way, radio frequency signal exchange between the first antenna element 1121 of the first radiating element 112 and another apparatus is completed.

As shown in FIG. 4, the second radiating element 113 may include a second antenna element 1131 and a second balun structure 1132. The second balun structure 1132 is located between the second antenna element 1131 and the metal ground plane 111, and the second balun structure 1132 is electrically connected to the second antenna element 1131 and the metal ground plane 111. Same as that of the first radiating element 112 in the foregoing embodiment, a radio frequency signal can be transmitted between the second antenna element 1131 and the metal ground plane 111 via the second balun structure 1132, to complete radio frequency signal exchange between the second antenna element 1131 of the second radiating element 113 and the another apparatus.

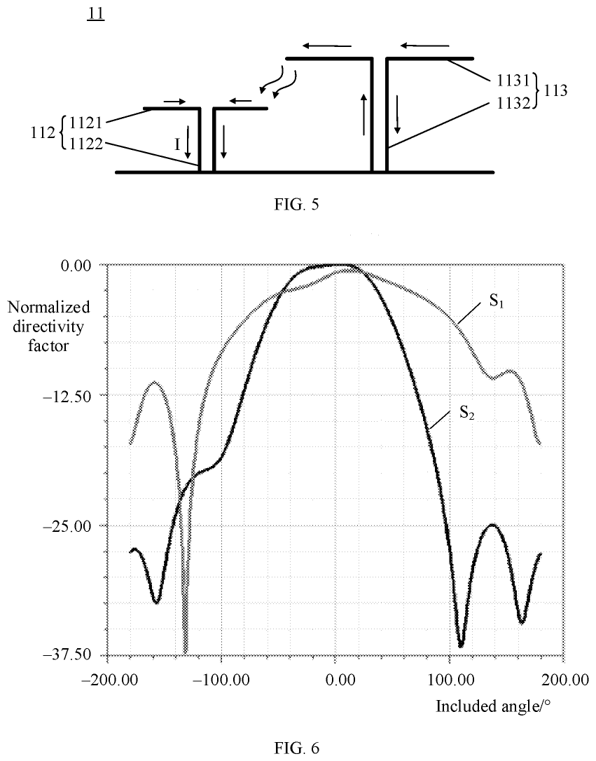

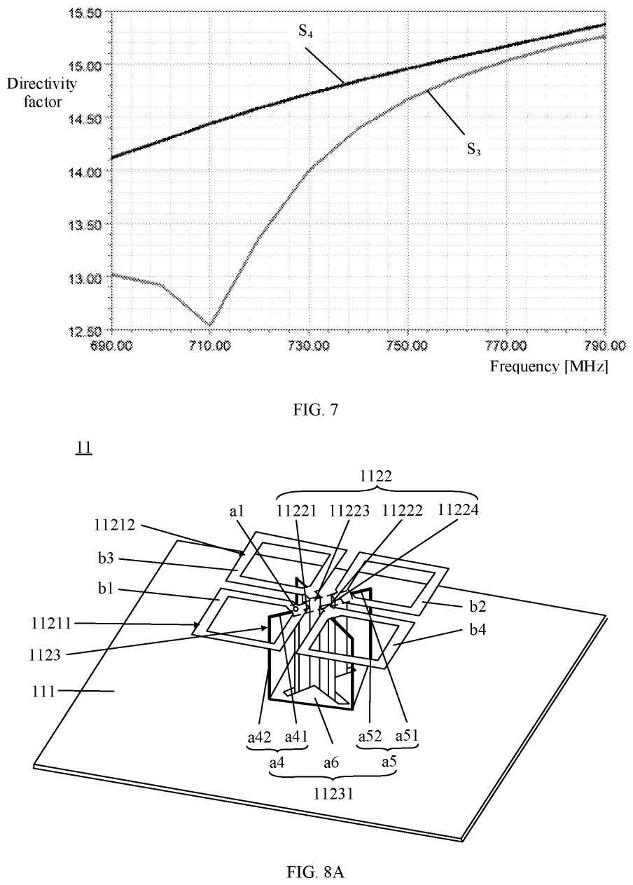

As shown in FIG. 5, in a related technology, when the second radiating element 113 operates, under impact of the electromagnetic wave that has the second frequency f₂ and is sent by the second radiating element 113, a magnetic field around the first balun structure 1122 of the first radiating element 112 periodically changes, and then an induced current having the second frequency f₂ is generated in the first balun structure 1122. In this case, the first balun structure 1122 generates an electromagnetic wave having the second frequency f₂, which causes interference to an electromagnetic wave signal that has the second frequency f₂ and is sent by the second radiating element 113, deteriorates a scattering parameter of the second radiating element 113, and results in distortion of a radiation pattern of the second radiating element 113. FIG. 6 is a diagram of a relationship between a normalized directivity factor and an included angle between a direction perpendicular to the metal ground plane and a radiation direction of the second radiating element 113 in three-dimensional space when the second frequency of the second radiating element 113 is 750 MHz. It can be learned from a curve S₁ that, in the related technology, the second radiating element 113 has poor directional symmetry, that is, the first radiating element 112 causes severe interference to the second radiating element 113. FIG. 7 is a diagram of a relationship between the second frequency and a directivity factor of the second radiating element 113. It can be learned from a curve S₃ that, in the related technology, the second radiating element 113 has a small directivity factor, that is, the second radiating element 113 has a small gain.

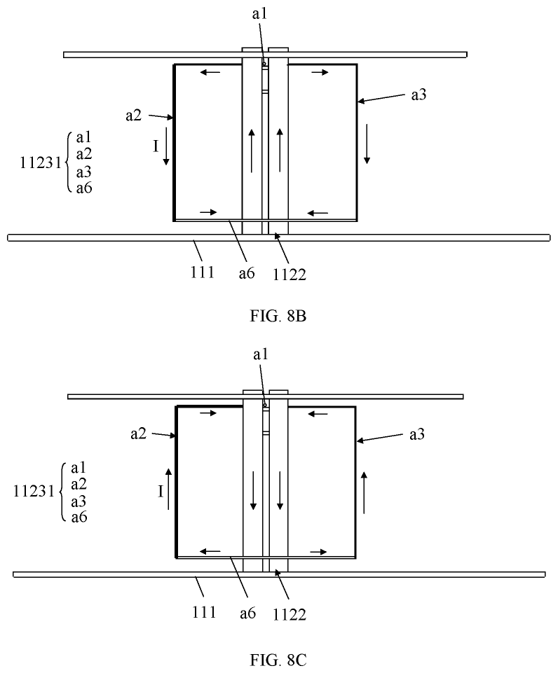

To resolve the foregoing problems, as shown in FIG. 8A, the first radiating element 112 (as shown in FIG. 4) may include a decoupling structure 1123. The decoupling structure 1123 is insulated from the metal ground plane 111, and the decoupling structure 1123 includes at least one primary split-ring stub 11231. The primary split-ring stub 11231 is located between the first antenna element 1121 (as shown in FIG. 4) and the metal ground plane 111. At least a part of the primary split-ring stub 11231 extends across the metal ground plane 111. In addition, an end of the primary split-ring stub 11231 facing away from the metal ground plane 111 is provided with a first opening a1. Both ends of the primary split-ring stub 11231 at the first opening a1 are electrically connected to the first balun structure 1122. When the second radiating element 113 (as shown in FIG. 4) operates, and an induced current having the second frequency f₂ is generated in the first balun structure 1122, a direction of the induced current alternates at a frequency of f₂. In this case, an alternating current having the second frequency f₂ is also generated in the primary split-ring stub 11231.

As shown in FIG. 8B, when the direction of the induced current in the first balun structure 1122 is a direction facing away from the metal ground plane 111, that is, when the induced current flows, to a connection point between the primary split-ring stub 11231 and the first balun structure 1122, from an end of the first balun structure 1122 facing the metal ground plane 111, a current flowing, to the primary split-ring stub 11231, from the connection point between the primary split-ring stub 11231 and the first balun structure 1122 is generated in the primary split-ring stub 11231. In addition, the at least part of the primary split-ring stub 11231 extends across the metal ground plane 111, and the first opening a1 is located in the end facing away from the metal ground plane 111. In other words, when the current flows through the primary split-ring stub 11231, a direction of a current in the at least part of the primary split-ring stub 11231 faces the metal ground plane 111. In other words, the direction of the current in the part is opposite to the direction of the current in the first balun structure 1122.

As shown in FIG. 8C, when the direction of the induced current in the first balun structure 1122 is a direction facing the metal ground plane 111, that is, when the induced current flows, to the end of the first balun structure 1122 facing the metal ground plane 111, from the connection point between the primary split-ring stub 11231 and the first balun structure 1122, a current flowing to the connection point between the primary split-ring stub 11231 and the first balun structure 1122 is generated in the primary split-ring stub 11231. The at least part of the primary split-ring stub 11231 extends across the metal ground plane 111, and the direction of the current in the part faces away from the metal ground plane 111. In other words, the direction of the current in the part is still opposite to the direction of the current in the first balun structure 1122.

In conclusion, the direction of the current in the at least part of the primary split-ring stub 11231 is always opposite to the direction of the current in the first balun structure 1122, and directions of generated magnetic fields are also opposite. In other words, when the second radiating element 113 (as shown in FIG. 4) operates normally, the induced current is generated in the first balun structure 1122 of the first radiating element 112 (as shown in FIG. 4), and the magnetic field is generated through electromagnetic induction, the primary split-ring stub 11231 of the decoupling structure 1123 (as shown in FIG. 8A) generates the magnetic field in the opposite direction, to reduce intensity of a total magnetic field generated by the first radiating element 112, thereby reducing intensity of the electromagnetic wave sent from the first radiating element 112. Still as shown in FIG. 6, it can be learned from a curve S₂ that, in this embodiment of this application, the second radiating element 113 has good directional symmetry, that is, the first radiating element 112 causes little interference to the second radiating element 113. Still as shown in FIG. 7, it can be learned from a curve S₄ that a directivity factor of the second radiating element 113 in this embodiment of this application is always greater than a directivity factor in a related technology, that is, the second radiating element 113 in this embodiment of this application has a large gain. This proves that, in this embodiment of this application, the first radiating element 112 causes the little interference to the second radiating element 113, and has good directivity. In this way, interference from the first radiating element 112 to the second radiating element 113 in the antenna array is reduced. In other words, interference from a high-frequency radiating element to a low-frequency radiating element in the antenna array 11 is reduced.

In addition, as shown in FIG. 8A, the decoupling structure 1123 is insulated from the metal ground plane 111, to prevent the decoupling structure 1123 from being electrically connected to the metal ground plane 111 directly, without directly connecting the decoupling structure 1123 to the metal ground plane 111, thereby ensuring normal operating of the antenna array 11.

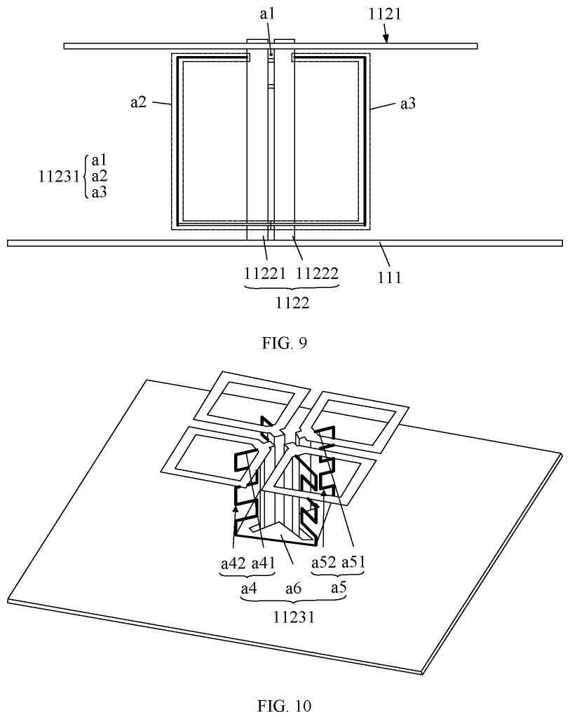

In some embodiments of this application, as shown in FIG. 9, the primary split-ring stub 11231 includes a first part a2 and a second part a3, and electrical lengths of the first part a2 and the second part a3 are equal. In addition, the first opening a1 is provided between an end of the first part a2 facing away from the metal ground plane 111 and an end of the second part a3 facing away from the metal ground plane 111. The first balun structure 1122 includes a first balun arm 11221 and a second balun arm 11222, and both the first balun arm 11221 and the second balun arm 11222 are connected to the metal ground plane 111. The end of the first part a2 facing away from the metal ground plane 111 is electrically connected to the first balun arm 11221. A length of the first part a2 is D₁, a distance between a connection point between the first part a2 and the first balun arm 11221 and a connection point between the first balun arm 11221 and the metal ground plane 111 is H₁, and λ_{H}/4D₁+H₁λ_{L}/2. The end of the second part a3 facing away from the metal ground plane 111 is electrically connected to the second balun arm 11222. A length of the second part a3 is D₂, a distance between a connection point between the second part a3 and the second balun arm 11222 and a connection point between the second balun arm 11222 and the metal ground plane 111 is H₂, and λ_{H}/4≤D₂+H₂≤λ_{L}/2. Herein, λ_{H} is a wavelength corresponding to the first frequency f₁ of the first radiating element 112 (as shown in FIG. 4), and λ_{L} is a wavelength corresponding to the second frequency f₂ of the second radiating element 113 (as shown in FIG. 4).

When D₁+H₁≤λ_{L}/2, and a direction of an electromagnetic wave in the second radiating element 113 (as shown in FIG. 4) does not change, directions of the current in the first balun arm 11221 and currents in all parts of the first part a2 all remain unchanged; and when the direction of the electromagnetic wave in the second radiating element 113 changes, the directions of the current in the first balun arm 11221 and the currents in all the parts of the first part a2 change at the same time. In this case, a direction of an electromagnetic wave generated by the first balun arm 11221 is always opposite to a direction of an electromagnetic wave generated by at least one section of the first part a2, to implement reverse cancellation. Similarly, when D₂+H₂≤λ_{L}/2, a direction of an electromagnetic wave generated by the second balun arm 11222 is always opposite to a direction of an electromagnetic wave generated by at least one section of the second part a3, to implement reverse cancellation.

However, when D₁+H₁≥λ_{L}/2, and the direction of the electromagnetic wave in the second radiating element 113 (as shown in FIG. 4) changes, a change of a current in a section of the first part a2 close to a connection point between the first part a2 and the second part a3 is delayed, and consequently, a flow direction of the current in the section is opposite to a flow direction of a current in another section of the first part a2. As a result, a magnetic field generated by the section of the first part a2 cannot reversely cancel a magnetic field generated by the first balun arm 11221, and the interference from the first radiating element 112 (as shown in FIG. 4) to the second radiating element 113 in the antenna array 11 cannot be reduced. Similarly, when D₂+H₂≥λ_{L}/2, a change of a current in a section of the second part a3 close to the connection point between the second part a3 and the first part a2 is delayed, and consequently, a flow direction of the current in the section is opposite to the flow direction of the current in the another section of the first part a2. As a result, the magnetic field generated by the section of the first part a2 cannot reversely cancel a magnetic field generated by the second balun arm 11222, and the interference from the first radiating element 112 (as shown in FIG. 4) to the second radiating element 113 in the antenna array 11 cannot be reduced.

In addition, in a radiating element, a magnitude of impedance is related to a structure form and an outline dimension, and is also related to an operating frequency of the radiating element. When D₁+H₁≥λ_{H}/4, and the first radiating element 112 (as shown in FIG. 4) operates normally, in an environment in which the first frequency f₁ is high, impedance of the first part a2 of the decoupling structure 1123 (as shown in FIG. 8A) is large, and is far greater than impedance of the first balun arm 11221, and a current flowing to the first part a2 is far lower than the current in the first balun arm 11221. In this case, an electromagnetic wave generated by the first part a2 may be ignored, that is, impact of the decoupling structure 1123 on operating of the first radiating element 112 may be ignored. Similarly, when D₂+H₂≥λ_{H}/4, an electromagnetic wave generated by the second part a3 may be ignored, that is, impact of the decoupling structure 1123 on operating of the first radiating element 112 may be ignored.

In some embodiments of this application, still as shown in FIG. 8A, the primary split-ring stub 11231 may include a first stub a4, a second stub a5, and an electrical connector a6. The first stub a4 and the second stub a5 are respectively located on two sides of the first balun structure 1122. A first end of the first stub a4 and a first end of the second stub a5 are electrically connected to the first balun structure 1122 separately. The first opening a1 is provided between the first end of the first stub a4 and the first end of the second stub a5.

Still as shown in FIG. 8B, the first end of the first stub a4 and the first end of the second stub a5 are electrically connected to the first balun structure 1122 separately. When the direction of the induced current in the first balun structure 1122 is the direction facing away from the metal ground plane 111, the induced current flows, to the first end of the first stub a4, from the end of the first balun structure 1122 facing the metal ground plane 111, and flows to the electrical connector a6 through the first stub a4. In addition, at least a part of the first stub a4 extends across the metal ground plane 111, that is, a direction of a current in the part faces the metal ground plane 111. In this way, a magnetic field whose direction is opposite to that of the magnetic field generated by the first balun structure 1122 can be generated.

Still as shown in FIG. 8C, when the direction of the induced current in the first balun structure 1122 is a direction facing the metal ground plane 111, the induced current flows, toward the metal ground plane 111, from a joint between the first end of the first stub a4 and the first balun structure 1122 to the end of the first balun structure 1122 facing the metal ground plane 111. In this case, electrical potential of the first end of the first stub a4 is less than electrical potential of a second end, and then a current flowing from the second end to the first end is generated in the first stub a4. In this case, a direction of the current in the first stub a4 faces away from the metal ground plane 111. In this way, a magnetic field whose direction is opposite to that of the magnetic field generated by the first balun structure 1122 can be generated. Therefore, the magnetic field whose direction is opposite to that of the magnetic field generated by the first balun structure 1122 is always generated in the first stub a4, to weaken the magnetic field generated by the first radiating element 112 (as shown in FIG. 4). In this way, the interference from the first radiating element 112 (namely, the high-frequency radiating element) to the second radiating element 113 (as shown in FIG. 4) (namely, the low-frequency radiating element) in the antenna array 11 is reduced.

In addition, still as shown in FIG. 8A, at least a part of the second stub a5 extends across the metal ground plane 111. Similarly, a magnetic field whose direction is opposite to that of the magnetic field generated by the first balun structure 1122 can also be generated on the at least part of the second stub a5, to further weaken the magnetic field generated by the first radiating element 112 (as shown in FIG. 4). In this way, the interference from the first radiating element 112 (namely, the high-frequency radiating element) to the second radiating element 113 (as shown in FIG. 4) (namely, the low-frequency radiating element) in the antenna array 11 is reduced.

On this basis, still as shown in FIG. 8A, the electrical connector a6 is located between the first stub a4 and the second stub a5, and is electrically connected to the second end of the first stub a4 and a second end of the second stub a5. The electrical connector a6 can electrically connect the first stub a4 to the second stub a5. This can reduce impedance of the primary split-ring stub 11231, to increase currents generated by the first stub a4 and the second stub a5, and ensure that intensity of the magnetic fields generated by the first stub a4 and the second stub a5 can furthest weaken the magnetic field generated by the first balun structure 1122.

In some embodiments of this application, still as shown in FIG. 8A, the first stub a4 may include a first horizontal stub a41 and a first vertical stub a42. The first opening a1 is provided between an end of the first horizontal stub a41 facing away from the first balun structure 1122 and the first end of the second stub a5. The first horizontal stub a41 is parallel to the metal ground plane 111, and an end of the first horizontal stub a41 facing the first balun structure 1122 is electrically connected to the first balun structure 1122. An end of the first vertical stub a42 facing away from the metal ground plane 111 is electrically connected to the end of the first horizontal stub a41 facing away from the first balun structure 1122, to ensure that the first vertical stub a42 is electrically connected to the first balun structure 1122. In addition, the first vertical stub a42 is perpendicular to the metal ground plane 111. In this way, a current whose direction is opposite to that of the current in the first balun structure 1122 can be generated in the first vertical stub a42. In this way, a direction of a magnetic field generated by the first vertical stub a42 is opposite to that of the magnetic field generated by the first balun structure 1122. This can achieve reverse cancellation effect, to weaken the magnetic field generated by the first radiating element 112 (as shown in FIG. 4), thereby reducing the intensity of the electromagnetic wave sent from the first radiating element 112. In this way, the interference from the first radiating element 112 (namely, the high-frequency radiating element) to the second radiating element 113 (as shown in FIG. 4) (namely, the low-frequency radiating element) in the antenna array 11 is reduced.

On this basis, still as shown in FIG. 8A, an end of the first vertical stub a42 facing the metal ground plane 111 is electrically connected to the electrical connector a6. In this case, the impedance of the primary split-ring stub 11231 is small, to increase the current generated in the first vertical stub a42, and ensure that intensity of the magnetic field generated by the first vertical stub a42 can greatly weaken the magnetic field generated by the first balun structure 1122.

Further, still as shown in FIG. 8A, the second stub a5 may include a second horizontal stub a51 and a second vertical stub a52. The second horizontal stub a51 is parallel to the metal ground plane 111, an end of the second horizontal stub a51 facing the first balun structure 1122 is electrically connected to the first balun structure 1122, and the first opening a1 is provided between the end of the second horizontal stub a51 facing the first balun structure 1122 and the first end of the first stub a4. The second vertical stub a52 is perpendicular to the metal ground plane 111, an end of the second vertical stub a52 facing away from the metal ground plane 111 is electrically connected to an end of the second horizontal stub a51 facing away from the first balun structure 1122, and an end of the second vertical stub a52 facing the metal ground plane 111 is electrically connected to the electrical connector a6. Same as that of the first stub a4 in the foregoing embodiment, such disposition can also ensure that a direction of a magnetic field generated by the second vertical stub a52 is opposite to that of the magnetic field generated by the first balun structure 1122. This can achieve the reverse cancellation effect, to weaken the magnetic field generated by the first radiating element 112 (as shown in FIG. 4), thereby reducing the intensity of the electromagnetic wave sent from the first radiating element 112. In this way, the interference from the first radiating element 112 (namely, the high-frequency radiating element) to the second radiating element 113 (as shown in FIG. 4) (namely, the low-frequency radiating element) in the antenna array 11 is reduced.

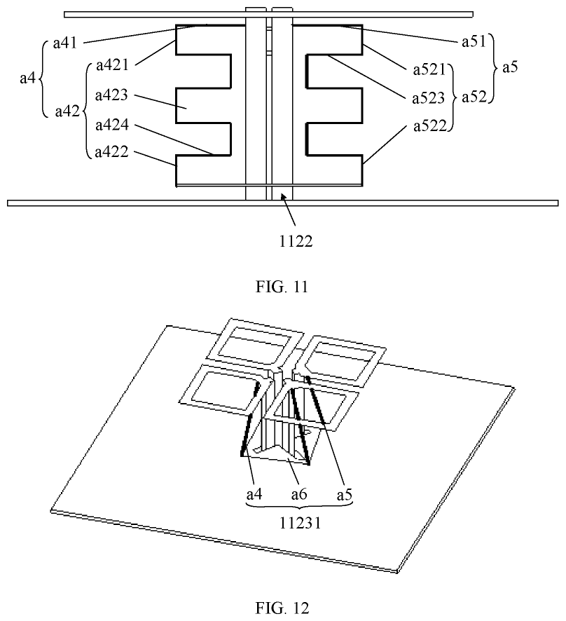

In some other embodiments of this application, as shown in FIG. 10 and FIG. 11, the first vertical stub a42 includes a first longitudinal section a421, a second longitudinal section a422, and a first U-shaped section a423. The first longitudinal section a421 is electrically connected to the end of the first horizontal stub a41 facing away from the first balun structure 1122, and the second longitudinal section a422 is electrically connected to the electrical connector a6. The first U-shaped section a423 is transversely disposed between the first longitudinal section a421 and the second longitudinal section a422, and the first U-shaped section a423 is electrically connected to the first longitudinal section a421 and the second longitudinal section a422 separately. In this case, currents whose directions are opposite to the direction of the current in the first balun structure 1122 can be generated in all of the first longitudinal section a421, the second longitudinal section a422, and a section of the first U-shaped section a423 facing away from an opening, to achieve the reverse cancellation effect. In addition, when a height of the first balun structure 1122 is low, or available space on a periphery of the first balun structure 1122 is small, the first stub a4 uses a manner of sequentially connecting the first longitudinal section a421, the first U-shaped section a423, and the second longitudinal section a422. This can increase a length of the first vertical stub a42, to ensure that D₁+H₁≥λ_{H}/4, thereby ensuring that, when the first radiating element 112 (as shown in FIG. 4) operates normally, the impedance of the primary split-ring stub 11231 is far greater than the impedance of the first balun arm 11221, and the current flowing to the first part a2 is far lower than the current in the first balun arm 11221. In this case, the electromagnetic wave generated by the first part a2 may be ignored, that is, the impact of the decoupling structure 1123 on operating of the first radiating element 112 may be ignored.

Further, still as shown in FIG. 11, the first vertical stub a42 may further include a third vertical section a424 and at least two first U-shaped sections a423. The third vertical section a424 is disposed between the two first U-shaped sections a423, and is electrically connected to the two first U-shaped sections a423 separately. The at least two first U-shaped sections a423 are disposed, to further ensure that D₁+H₁≥λ_{H}/4.

Certainly, still as shown in FIG. 10 and FIG. 11, the second vertical stub a52 may include a fourth longitudinal section a521, a fifth longitudinal section a522, and a second U-shaped section a523. The fourth longitudinal section a521 is electrically connected to the end of the second horizontal stub a51 facing away from the first balun structure 1122, and the fifth longitudinal section a522 is electrically connected to the electrical connector a6. The second U-shaped section a523 is transversely disposed between the first longitudinal section a421 and the second longitudinal section a422, and the second U-shaped section a523 is electrically connected to the fourth longitudinal section a521 and the fifth longitudinal section a522 separately. Same as that in the foregoing embodiment, such disposition can ensure that D₂+H₂≥λ_{H}/4, to ensure that, when the first radiating element 112 (as shown in FIG. 4) operates normally, the impedance of the primary split-ring stub 11231 is far greater than impedance of the second balun arm 11222, and a current flowing to the second part a3 is far lower than a current in the second balun arm 11222. In this case, the electromagnetic wave generated by the second part a3 may be ignored, that is, the impact of the decoupling structure 1123 on operating of the first radiating element 112 may be ignored.

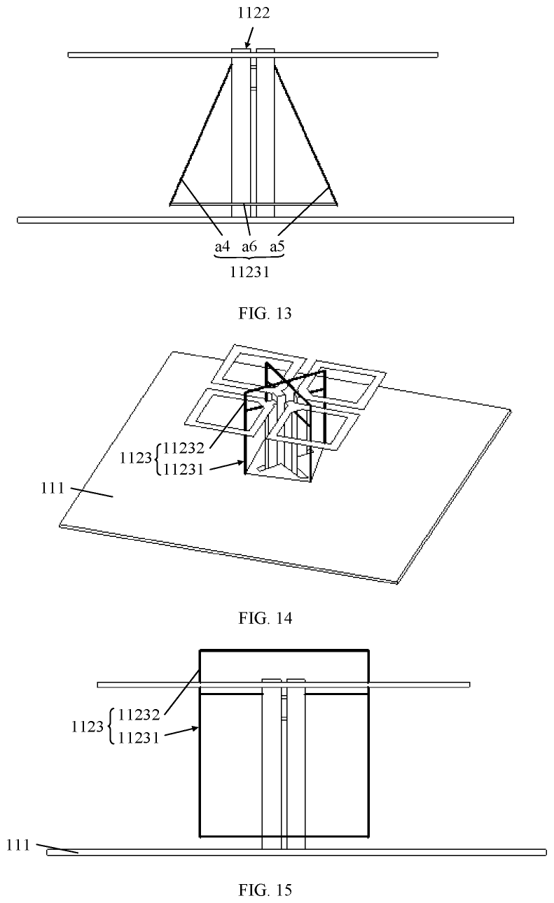

In some other embodiments of this application, as shown in FIG. 12 and FIG. 13, the first stub a4 may extend across the metal ground plane 111, the first end of the first stub a4 is disposed close to the first balun structure 1122, and the second end of the first stub a4 is disposed away from the first balun structure 1122. When available space in an area on a periphery of an upper half of the first balun structure 1122 is smaller, and available space in an area on a periphery of a lower half of the first balun structure 1122 is larger, it is ensured that the first stub a4 can be disposed on one side of the first balun structure 1122.

Certainly, still as shown in FIG. 13, the second stub a5 may extend across the metal ground plane 111, the first end of the second stub a5 is disposed close to the first balun structure 1122, and the second end of the second stub a5 is disposed away from the first balun structure 1122. Same as that in the foregoing embodiment, such disposition ensures that the second stub a5 can be disposed on one side of the first balun structure 1122.

In some embodiments of this application, still as shown in FIG. 8A, the first antenna element 1121 (as shown in FIG. 4) includes a first dipole element 11211, and the first dipole element 11211 includes a first sub-element b1 and a second sub-element b2. The first balun structure 1122 includes a first balun arm 11221 and a second balun arm 11222, the first balun arm 11221 is connected to the first sub-element b1, and the second balun arm 11222 is connected to the second sub-element b2. A radio frequency signal can be transmitted between the first sub-element b1 and the metal ground plane 111 via the first balun arm 11221, and a radio frequency signal can be transmitted between the second sub-element b2 and the metal ground plane 111 via the second balun arm 11222, to complete radio frequency signal exchange between the first dipole element 11211 of the first radiating element 112 (as shown in FIG. 4) and another apparatus.

Still as shown in FIG. 8A, the first end of the first stub a4 is electrically connected to the first balun arm 11221, and the first end of the second stub a5 is electrically connected to the second balun arm 11222. When the second radiating element 113 (as shown in FIG. 4) operates, because both the first balun arm 11221 and the second balun arm 11222 are in a magnetic field of the second radiating element 113, induced currents having the second frequency f₂ are generated in both the first balun arm 11221 and the second balun arm 11222, and directions of the induced currents are the same. In this case, the first end of the first stub a4 is electrically connected to the first balun arm 11221, to generate a current whose direction is opposite to that of the current in the first balun arm 11221, thereby weakening a magnetic field generated by the first balun arm 11221. Similarly, the second stub a5 can weaken a magnetic field generated by the second balun arm 11222. In this way, the intensity of the electromagnetic wave sent from the first radiating element 112 (as shown in FIG. 4) is weakened.

Further, still as shown in FIG. 8A, there may be two primary split-ring stubs 11231, the first antenna element 1121 further includes a second dipole element 11212, and the second dipole element 11212 includes a third sub-element b3 and a fourth sub-element b4. The first balun structure 1122 further includes a third balun arm 11223 and a fourth balun arm 11224, the third balun arm 11223 is connected to the third sub-element b3, and the fourth balun arm 11224 is connected to the fourth sub-element b4. A radio frequency signal can be transmitted between the third sub-element b3 and the metal ground plane 111 via the third balun arm 11223, and a radio frequency signal can be transmitted between the fourth sub-element b4 and the metal ground plane 111 via the fourth balun arm 11224, to complete radio frequency signal exchange between the second dipole element 11212 of the first radiating element 112 (as shown in FIG. 4) and the another apparatus. In addition, the first dipole element 11211 and the second dipole element 11212 operate in a transmit and receive duplex mode at the same time, which reduces a number of first radiating elements 112 that need to be disposed in the antenna array 11.

For example, the first balun structure may be a cross-shaped balun structure, or may be a straight-line-shaped balun structure. The second balun structure may be a cross-shaped balun structure, or may be a straight-line-shaped balun structure.

Still as shown in FIG. 8A, for one of the primary split-ring stubs 11231, a first end of a first stub a4 is electrically connected to the first balun arm 11221, and a first end of a second stub a5 is electrically connected to the second balun arm 11222. For the other primary split-ring stub 11231, a first end of a first stub a4 is electrically connected to the third balun arm 11223, and a first end of a second stub a5 is electrically connected to the fourth balun arm 11224. In addition, same as those in the foregoing embodiment, for the one of the primary split-ring stubs 11231, the first stub a4 can weaken the magnetic field generated by the first balun arm 11221, and the second stub a5 can weaken the magnetic field generated by the second balun arm 11222. For the other primary split-ring stub 11231, the first stub a4 can weaken a magnetic field generated by the third balun arm 11223, and the second stub a5 can weaken a magnetic field generated by the fourth balun arm 11224. In this way, the intensity of the electromagnetic wave sent from the first radiating element 112 (as shown in FIG. 4) is weakened.

In the foregoing embodiment, as shown in FIG. 8A, an example in which the decoupling structure 1123 includes two primary split-ring stubs 11231 is used. In another embodiment of this application, there may be another number of primary split-ring stubs 11231.

In some embodiments of this application, still as shown in FIG. 8A, the two primary split-ring stubs 11231 are electrically connected to each other at ends facing the metal ground plane 111. In this case, different primary split-ring stubs 11231 are connected in parallel, so that the decoupling structure 1123 has smaller total inductance and smaller total inductive reactance, to increase a magnitude of a current in the decoupling structure 1123. In this way, when the induced current is generated in the first balun structure 1122, the magnitude of the current in the decoupling structure 1123 is closer to that of the current in the first balun structure 1122, so that intensity of a magnetic field generated by the decoupling structure 1123 is close to the intensity of the magnetic field generated by the first balun structure 1122. This improves the reverse cancellation effect, and reduces the interference from the first radiating element 112 (as shown in FIG. 4) to the second radiating element 113 (as shown in FIG. 4) in the antenna array 11.

In addition, a formula of a frequency of a radiated electromagnetic wave of an LC oscillation circuit is as follows:

$$f = \frac{1}{2 π \sqrt{LC}}$$

Herein, f is the frequency of the radiated electromagnetic wave, Lis inductive reactance of a current line, and C is capacitive reactance of the current line.

When the decoupling structure 1123 has the smaller total inductance, the decoupling structure 1123 is applicable to a lower operating frequency of the second radiating element 113, so that the decoupling structure 1123 is applicable to a wider operating frequency band of the second radiating element 113.

As shown in FIG. 8A, the electrical connector a6 is a sheet-like structure and is parallel to the metal ground plane 111. In this case, compared with a linear structure, the sheet-like structure has smaller capacitance and larger capacitive reactance. In this way, capacitive reactance of the primary split-ring stub 11231 is large. According to the foregoing formula of the frequency of the radiated electromagnetic wave of the LC oscillation circuit, the capacitive reactance is inversely proportional to the frequency. In this case, the decoupling structure 1123 is applicable to a lower operating frequency of the second radiating element 113 (as shown in FIG. 4), so that the decoupling structure 1123 is applicable to a wider operating frequency band of the second radiating element 113.

In the foregoing embodiment, as shown in FIG. 8A, an example of the electrical connector a6 of the sheet-like structure is used. In another embodiment of this application, the electrical connector a6 may alternatively be of a structure in another shape, for example, a linear structure.

In some embodiments of this application, as shown in FIG. 14 and FIG. 15, the decoupling structure 1123 further includes at least one secondary split-ring stub 11232. The secondary split-ring stub 11232 is disposed on a side of the primary split-ring stub 11231 facing away from the metal ground plane 111, and an end of each secondary split-ring stub 11232 facing the metal ground plane 111 is electrically connected to the primary split-ring stub 11231. In this case, the primary split-ring stub 11231 and the secondary split-ring stub 11232 are connected in parallel, so that the parallel decoupling structure 1123 has smaller total inductance and smaller total inductive reactance. According to the foregoing formula of the frequency of the radiated electromagnetic wave of the LC oscillation circuit, the inductive reactance is inversely proportional to the frequency. In this case, the decoupling structure 1123 is applicable to a lower operating frequency of the second radiating element 113 (as shown in FIG. 4), so that the decoupling structure 1123 is applicable to a wider operating frequency band of the second radiating element 113.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. An antenna array, comprising:
a metal ground plane;
a first radiating element, having a first frequency f₁, wherein the first radiating element comprises:
a first antenna element;
a first balun structure, located between the first antenna element and the metal ground plane, wherein the first balun structure is electrically connected to the first antenna element and the metal ground plane; and
a decoupling structure, insulated from the metal ground plane, wherein the decoupling structure comprises at least one primary split-ring stub, the primary split-ring stub is located between the first antenna element and the metal ground plane, at least a part of the primary split-ring stub extends across the metal ground plane, an end of the primary split-ring stub facing away from the metal ground plane is provided with a first opening, and both ends of the primary split-ring stub at the first opening are electrically connected to the first balun structure; and
a second radiating element, disposed on the metal ground plane, wherein the second radiating element has a second frequency f₂, and f₂<f₁.

2. The antenna array according to claim 1, wherein the primary split-ring stub comprises:
a first stub, wherein at least a part of the first stub extends across the metal ground plane;
a second stub, wherein at least a part of the second stub extends across the metal ground plane, the first stub and the second stub are respectively located on two sides of the first balun structure, a first end of the first stub and a first end of the second stub are electrically connected to the first balun structure separately, and the first opening is provided between the first end of the first stub and the first end of the second stub; and
an electrical connector, located between the first stub and the second stub, and electrically connected to a second end of the first stub and a second end of the second stub.

3. The antenna array according to claim 2, wherein the first stub comprises:
a first horizontal stub, parallel to the metal ground plane, wherein an end of the first horizontal stub facing the first balun structure is electrically connected to the first balun structure, and the first opening is provided between an end of the first horizontal stub facing away from the first balun structure and the first end of the second stub; and
a first vertical stub, perpendicular to the metal ground plane, wherein an end of the first vertical stub facing away from the metal ground plane is electrically connected to the end of the first horizontal stub facing away from the first balun structure, and an end of the first vertical stub facing the metal ground plane is electrically connected to the electrical connector.

4. The antenna array according to claim 3, wherein the first vertical stub comprises a first longitudinal section, a second longitudinal section, and a first U-shaped section, the first longitudinal section is electrically connected to the end of the first horizontal stub facing away from the first balun structure, and the second longitudinal section is electrically connected to the electrical connector; and
the first U-shaped section is disposed between the first longitudinal section and the second longitudinal section, and the first U-shaped section is electrically connected to the first longitudinal section and the second longitudinal section separately.

5. The antenna array according to claim 2, wherein the first stub extends across the metal ground plane, the first end of the first stub is disposed close to the first balun structure, and the second end of the first stub is disposed away from the first balun structure.

6. The antenna array according to claim 2, wherein the second stub comprises:
a second horizontal stub, parallel to the metal ground plane, wherein an end of the second horizontal stub facing the first balun structure is electrically connected to the first balun structure, and the first opening is provided between the end of the second horizontal stub facing the first balun structure and the first end of the first stub; and
a second vertical stub, perpendicular to the metal ground plane, wherein an end of the second vertical stub facing away from the metal ground plane is electrically connected to an end of the second horizontal stub facing away from the first balun structure, and an end of the second vertical stub facing the metal ground plane is electrically connected to the electrical connector.

7. The antenna array according to claim 2, wherein the first antenna element comprises a first dipole element, and the first dipole element comprises a first sub-element and a second sub-element; and
the first balun structure comprises a first balun arm and a second balun arm, the first balun arm is connected to the first sub-element, the second balun arm is connected to the second sub-element, the first end of the first stub is electrically connected to the first balun arm, and the first end of the second stub is electrically connected to the second balun arm.

8. The antenna array according to claim 7, wherein there are two primary split-ring stubs, the first antenna element further comprises a second dipole element, and the second dipole element comprises a third sub-element and a fourth sub-element;
the first balun structure further comprises a third balun arm and a fourth balun arm, the third balun arm is connected to the third sub-element, and the fourth balun arm is connected to the fourth sub-element;
for one of the primary split-ring stubs, a first end of a first stub is electrically connected to the first balun arm, and a first end of a second stub is electrically connected to the second balun arm; and
for the other primary split-ring stub, a first end of a first stub is electrically connected to the third balun arm, and a first end of a second stub is electrically connected to the fourth balun arm.

9. The antenna array according to claim 8, wherein the two primary split-ring stubs are electrically connected to each other at ends facing the metal ground plane.

10. The antenna array according claim 2, wherein the electrical connector is a sheet-like structure and is parallel to the metal ground plane.

11. The antenna array according to claim 1, wherein the primary split-ring stub comprises a first part and a second part, the first part and the second part have equal electrical lengths, and the first opening is provided between an end of the first part facing away from the metal ground plane and an end of the second part facing away from the metal ground plane;
the first balun structure comprises a first balun arm and a second balun arm, both the first balun arm and the second balun arm are connected to the metal ground plane, the end of the first part facing away from the metal ground plane is electrically connected to the first balun arm, a length of the first part is D₁, a distance between a connection point between the first part and the first balun arm and a connection point between the first balun arm and the metal ground plane is H₁, and λ_{H}/4≤D₁+H₁≤λ_{L}/2; and
the end of the second part facing away from the metal ground plane is electrically connected to the second balun arm, a length of the second part is D₂, a distance between a connection point between the second part and the second balun arm and a connection point between the second balun arm and the metal ground plane is H₂, and λ_{H}/4≤D₂+H₂≤λ_{L}/2, wherein λ_{H} is a wavelength corresponding to the first frequency f₁ of the first radiating element, and λ_{L} is a wavelength corresponding to the second frequency f₂ of the second radiating element.

12. The antenna array according to claim 1, wherein the decoupling structure further comprises at least one secondary split-ring stub; and
the secondary split-ring stub is disposed on a side of the primary split-ring stub facing away from the metal ground plane, and an end of each secondary split-ring stub facing the metal ground plane is electrically connected to the primary split-ring stub.

13. An antenna structure, comprising an antenna array, wherein the antenna structure further comprises a radome, and the antenna array is disposed in the radome;
wherein the antenna array comprises a metal ground plane;
a first radiating element, having a first frequency f₁, wherein the first radiating element comprises:
a first antenna element;
a first balun structure, located between the first antenna element and the metal ground plane, wherein the first balun structure is electrically connected to the first antenna element and the metal ground plane; and
a decoupling structure, insulated from the metal ground plane, wherein the decoupling structure comprises at least one primary split-ring stub, the primary split-ring stub is located between the first antenna element and the metal ground plane, at least a part of the primary split-ring stub extends across the metal ground plane, an end of the primary split-ring stub facing away from the metal ground plane is provided with a first opening, and both ends of the primary split-ring stub at the first opening are electrically connected to the first balun structure; and
a second radiating element, disposed on the metal ground plane, wherein the second radiating element has a second frequency f₂, and f₂<f₁.

14. The antenna structure according to claim 13, wherein the primary split-ring stub comprises:
a first stub, wherein at least a part of the first stub extends across the metal ground plane;
a second stub, wherein at least a part of the second stub extends across the metal ground plane, the first stub and the second stub are respectively located on two sides of the first balun structure, a first end of the first stub and a first end of the second stub are electrically connected to the first balun structure separately, and the first opening is provided between the first end of the first stub and the first end of the second stub; and
an electrical connector, located between the first stub and the second stub, and electrically connected to a second end of the first stub and a second end of the second stub.

15. The antenna structure according to claim 14, wherein the first stub comprises:
a first horizontal stub, parallel to the metal ground plane, wherein an end of the first horizontal stub facing the first balun structure is electrically connected to the first balun structure, and the first opening is provided between an end of the first horizontal stub facing away from the first balun structure and the first end of the second stub; and
a first vertical stub, perpendicular to the metal ground plane, wherein an end of the first vertical stub facing away from the metal ground plane is electrically connected to the end of the first horizontal stub facing away from the first balun structure, and an end of the first vertical stub facing the metal ground plane is electrically connected to the electrical connector.

16. The antenna structure according to claim 15, wherein the first vertical stub comprises a first longitudinal section, a second longitudinal section, and a first U-shaped section, the first longitudinal section is electrically connected to the end of the first horizontal stub facing away from the first balun structure, and the second longitudinal section is electrically connected to the electrical connector; and
the first U-shaped section is disposed between the first longitudinal section and the second longitudinal section, and the first U-shaped section is electrically connected to the first longitudinal section and the second longitudinal section separately.

17. The antenna structure according to claim 14, wherein the first stub extends across the metal ground plane, the first end of the first stub is disposed close to the first balun structure, and the second end of the first stub is disposed away from the first balun structure.

18. The antenna structure according to claim 14, wherein the second stub comprises:
a second horizontal stub, parallel to the metal ground plane, wherein an end of the second horizontal stub facing the first balun structure is electrically connected to the first balun structure, and the first opening is provided between the end of the second horizontal stub facing the first balun structure and the first end of the first stub; and
a second vertical stub, perpendicular to the metal ground plane, wherein an end of the second vertical stub facing away from the metal ground plane is electrically connected to an end of the second horizontal stub facing away from the first balun structure, and an end of the second vertical stub facing the metal ground plane is electrically connected to the electrical connector.

19. The antenna structure according to claim 14, wherein the first antenna element comprises a first dipole element, and the first dipole element comprises a first sub-element and a second sub-element; and
the first balun structure comprises a first balun arm and a second balun arm, the first balun arm is connected to the first sub-element, the second balun arm is connected to the second sub-element, the first end of the first stub is electrically connected to the first balun arm, and the first end of the second stub is electrically connected to the second balun arm.

20. The antenna structure according to claim 19, wherein there are two primary split-ring stubs, the first antenna element further comprises a second dipole element, and the second dipole element comprises a third sub-element and a fourth sub-element;
the first balun structure further comprises a third balun arm and a fourth balun arm, the third balun arm is connected to the third sub-element, and the fourth balun arm is connected to the fourth sub-element;
for one of the primary split-ring stubs, a first end of a first stub is electrically connected to the first balun arm, and a first end of a second stub is electrically connected to the second balun arm; and
for the other primary split-ring stub, a first end of a first stub is electrically connected to the third balun arm, and a first end of a second stub is electrically connected to the fourth balun arm.
